(19) United States
(12) Patent Application Publication
(10) Pub. No.: US 2016/0199246 A1
(43) Pub. Date: Jul. 14, 2016

(54) UPPER LIMB REHABILITATION TRAINING APPARATUS

(71) Applicants: YEUNG KI KIM, (US); KIBEOM KIM, (US)

(72) Inventors: YEUNG KI KIM, Daegu (KR); KIBEOM KIM, Daegu (KR); KYEONGMIN KIM, Daegu (KR); SIWOO KIM, Daegu (KR)

(21) Appl. No.: 14/748,154

(22) Filed: Jun. 23, 2015

(30) Foreign Application Priority Data
Jan. 14, 2015 (KR) 10-2015-0006823

(51) Int. Cl. A61H 1/02; A63B 23/12; A63B 23/16; A63B 23/035; A63B 23/14

(52) U.S. Cl. CPC A61H 1/0285; A61H 1/0214; A63B 23/03508; A63B 23/14; A63B 23/16; A63B 23/1281; A61H 1/0288; A61H 2001/0203; A63B 2023/006

(57) ABSTRACT

An upper limb rehabilitation training apparatus is provided. The upper limb rehabilitation training apparatus includes an arm rest provided in a longitudinal direction of an arm of a patient, a hand rest rotatably mounted with respect to the arm rest and on which a hand of the patient is placed, finger support rods provided in plurality to protrude from a top surface of the hand rest, the finger support rods varying in distance therebetween while supporting fingers or a palm of the patient, and a rotation driving part providing a driving force so that the hand rest rotates to allow the wrist of the patient to be stretched.

### CROSS-REFERENCE TO RELATED APPLICATIONS

The present application claims priority under 35 U.S.C. 119 and 35 U.S.C. 365 to Korean Patent Application No. 10-2015-0006823 (filed on Jan. 14, 2015), which is hereby incorporated by reference in its entirety.

### BACKGROUND

The present disclosure relates to an upper limb rehabilitation training apparatus, which is used for both hands, allowing stiffened wrist and finger to be mounted thereon and both hands to be stretched.

In general, hemiplegia is a movement disorder accompanied by paralysis generated due to injury of central nervous system such as cerebral apoplexy, or traumatic brain injury. The hemiplegia may be caused due to a sensory defect, an imbalance of posture, and a lack of physical self-consciousness ability and one of the movement disorders in which it is impossible to use a paralyzed muscle at a desired moment so that an appropriate power is generated.

Since spasticity shown in the hemiplegic patient disturbs to renew the patient's strength and causes arthrogryposis, a treatment for making a joint flexible depending on a manipulation therapy by a rehabilitation therapist is being performed.

Generally, a patient having a stiffened upper limb has a stiffened hand of which fingers are curved. The rehabilitation therapist performs the manipulation therapy for stretching the stiffened thumb and the rest of fingers.

However, when the patient depends on the manipulation therapy by the rehabilitation therapist, a lot of treatment time is needed, and also treatment efficiency decreases. Thus, an automatic rehabilitation machine is being used.

An automatic sports machine for hands in which an elbow, a wrist portion, a palm, and a thumb are placed on a grasp part, and a thumb is inserted into a thumb moving part, and then a finger drawing part and the thumb moving part are driven to stretch the wrist and the thumb is disclosed in Korean Patent Registration No. 1359747.

However, according to the related art, since it is difficult to insert the finger curved and contractured due to the paralysis into the grasp part and the thumb moving part, the patient or a caregiver may not easily use the machine. Also, there is a necessity to separately provide a left hand exclusive sports machine and a right hand exclusive sports machine due to the structure of the grasp part and the thumb moving part.

### SUMMARY

Embodiments provide an upper limp rehabilitation training apparatus, which is used for both hands, allowing stiffened wrist and fingers to be mounted thereon and both hands to be stretched.

In one embodiment, an upper limb rehabilitation training apparatus includes: an arm rest provided in a longitudinal direction of an arm of a patient; a hand rest rotatably mounted with respect to the arm rest and on which a hand of the patient is placed; finger support rods provided in plurality to protrude from a top surface of the hand rest, the finger support rods varying in distance therebetween while supporting fingers or a palm of the patient; and a rotation driving part providing a driving force so that the hand rest rotates to allow the wrist of the patient to be stretched.

The details of one or more embodiments are set forth in the accompanying drawings and the description below. Other features will be apparent from the description and drawings, and from the claims.

### BRIEF DESCRIPTION OF THE DRAWINGS

FIGS. 1, 2 and 3 are views of an upper limb rehabilitation training apparatus according to an embodiment.

FIG. 4 is a block diagram illustrating an operation of the upper limb rehabilitation training apparatus according to an embodiment.

FIGS. 5, 6, 7 and 8 are views minutely illustrating a thumb guide part mountable on the upper limb rehabilitation training apparatus and an operation of the rehabilitation training apparatus.

### DETAILED DESCRIPTION OF THE EMBODIMENTS

Reference will now be made in detail to the embodiments of the present disclosure, examples of which are illustrated in the accompanying drawings.

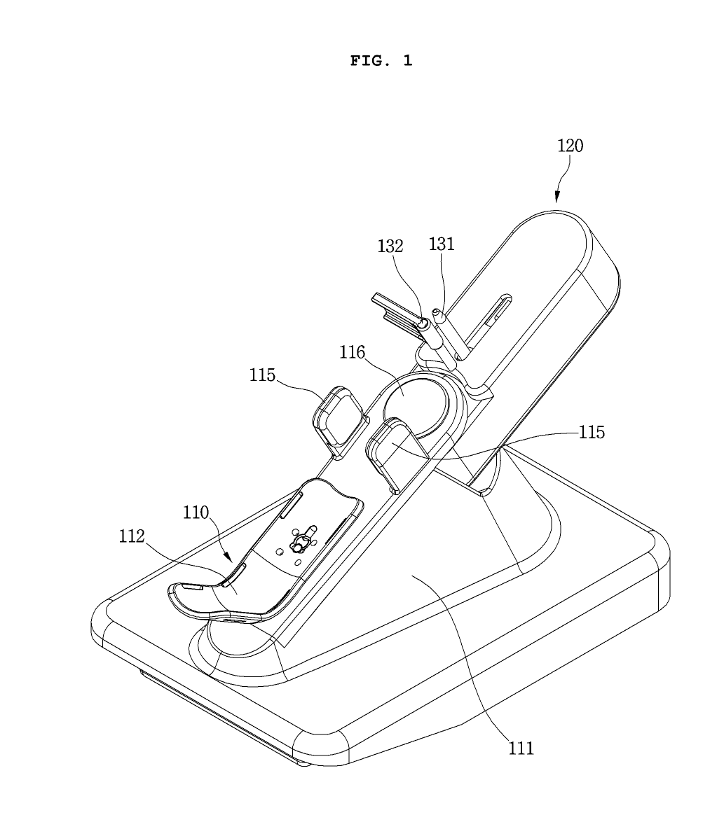

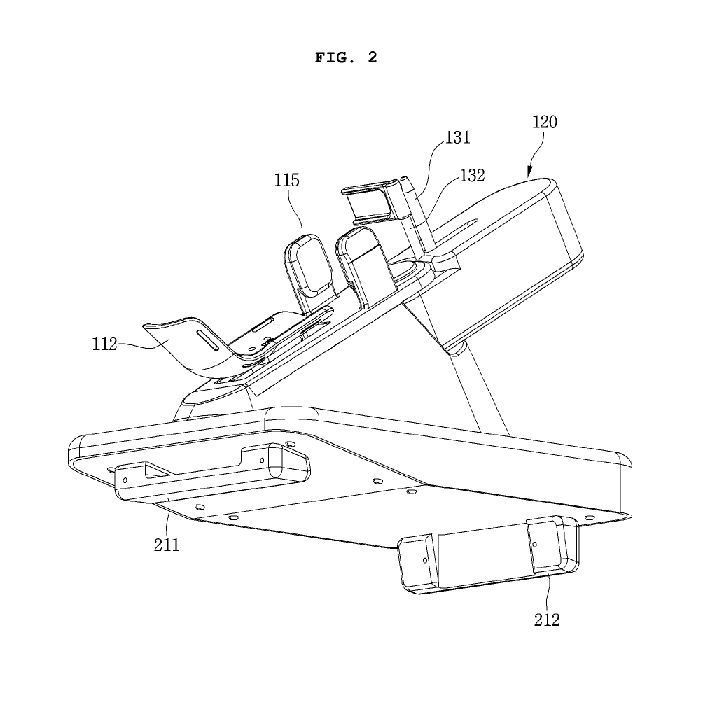

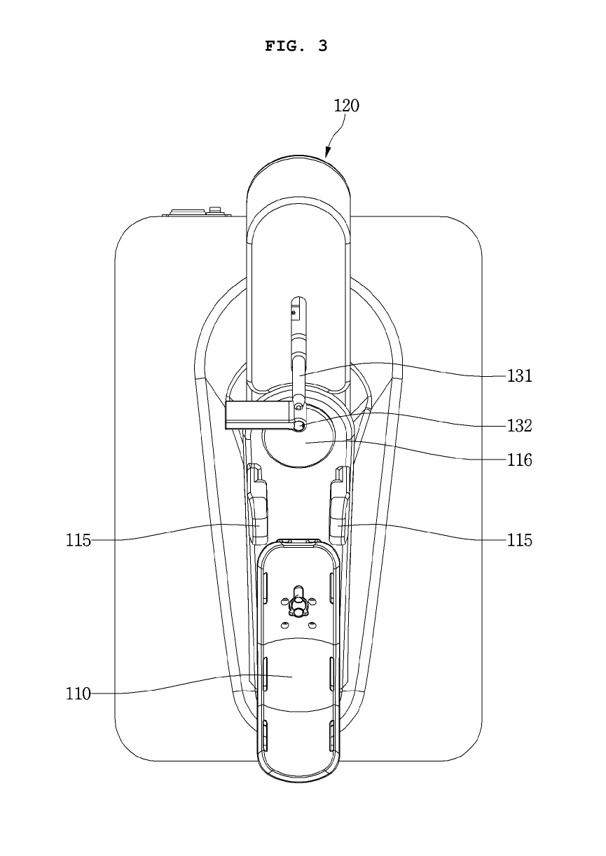

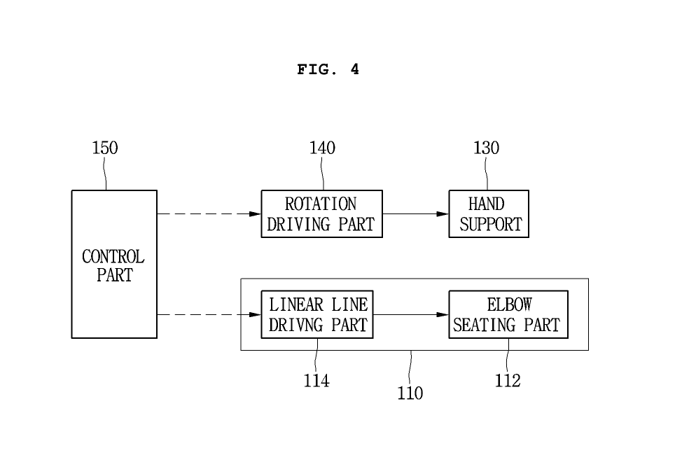

FIGS. 1 to 3 are views of an upper limb rehabilitation training apparatus according to an embodiment, and FIG. 4 is a block diagram illustrating an operation of the upper limb rehabilitation training apparatus according to an embodiment.

Referring to FIGS. 1 to 4, an upper limb rehabilitation training apparatus includes an arm rest 110 on which an arm is naturally placed and a hand rest 120 on which a hand is naturally placed, which are disposed in a line.

Also, a pair of finger support rods 131 and 132 for supporting a curved and stiffened fingers or palm are disposed on the hand rest 120. Also, a rotation driving part 140 for rotating the hand rest 120 with respect to the arm rest 110 on the same plane and a control part 150 for controlling the rotation driving part 140 are provided.

In detail, a brachial part of an arm of a patient is longitudinally disposed on the arm rest 110. In the current embodiment, the arm rest 110 includes a main body 111, an elbow seating part 112, a position adjusting part, a linear line driving part 114, arm fixing parts 115, and a wrist seating part 116.

The main body 111 has an inclined surface longitudinally inclined upward on an upper portion thereof with respect to a floor surface to inclinedly support from an elbow to the wrist upward.

Also, a first height adjusting part 211 and a second height adjusting part 212 for adjusting an inclined angle of the elbow and the wrist according to the patients are disposed on a lower portion of the main body 111. The patient may adjust a length, which protrudes from a bottom surface of the main body 111, of each of the first and second height adjustment parts 211 and 212, to adjust an inclined angle of the main body 111.

The elbow seating part 112 has an opened and curved top surface so that the elbow of the patient is seated thereon. The elbow seating part 112 is disposed on a top surface of the main body 111. Of course, the elbow seating part 112 may support a rear portion of the elbow or a portion of a forearm part so that the elbow is supported on an inclined surface.

The position adjusting part may adjust a position of the elbow seating part 112 along a longitudinal direction of the main body 111. The position adjusting part may adjust an initial position of the elbow seating part 112 according to a length of the arm of patient.

The linear line driving part 114 is a driving motor capable of allowing the position of the elbow seating part 112 to linearly reciprocate along the longitudinal direction of the main body 111. The linear line driving part 114 may be built in the main body 111. An operation of the linear line driving part 114 may be controlled by the control part 150.

Also, the linear line driving part 114 may be omitted, and a caregiver or a rehabilitation therapist may allow the elbow seating part 112 to directly linearly reciprocate. The linear line driving part 114 will not be limited to the embodiment.

The arm fixing parts 115 are provided with a pair of plates disposed a predetermined distance apart from each other so that the arm is easily fitted therein. The arm fixing parts 115 are disposed on the top surface of the main body 111. Here, predetermined elastic parts for elastically supporting both sides of the arm are disposed on the arm fixing parts 115, respectively, to face each other. Alternatively, a belt (not shown) for additionally fixing the arm may be disposed on the arm fixing part 115. The arm fixing parts 115 will not be limited to the embodiment.

The wrist fixing part 116 is an elastic part that is provided to allow the wrist of the patient to be comfortably supported thereon. The wrist fixing part 116 is disposed on the top surface of the main body 111.

The hand rest 120 has a plate shape longitudinally provided on the same plane with respect to the top surface of the arm rest 110. The hand rest 120 may support a hand edge that is a portion from a little finger to the wrist. The hand rest 120 is rotatably disposed on an upper end of the arm rest 110.

Each of the finger support rods 131 and 132 has a rod shape protruding upward from the hand rest 120. The finger support rods 131 and 132 may support the fingers or palm in a palm direction of the patient. Two finger support rods 131 and 132 are disposed a predetermined distance apart from each other on a central portion of the hand rest 120 in the longitudinal direction.

Also, one of the finger support rods 131 and 132 may be movably disposed in the longitudinal direction of the hand rest 120. An initial position of each of the finger support rods 131 and 132 may be adjusted according to a size of the hand of the patient.

Of course, a right hand may be seated on a right side of the hand rest 120 with respect to the finger support rods 131 and 132, and a left hand may be seated on a left side of the hand rest 120 with respect to the finger support rods 131 and 132.

The rotation driving part 140 is a driving motor capable of rotationally driving the hand rest 120 with respect to the uppermost end of the arm rest 110. The rotation driving part 140 may be built in the main body 111.

Here, the rotation driving part 140 may rotatably driving the hand rest 120 in a range of about 120° in both directions with respect to the arm rest 120. An operation of the rotation driving part 140 may be adjusted by the control part 150.

Also, the rotation driving part 140 may rotate the hand rest 120 by using an elastic force of a rubber band and will not be limited to the embodiment.

The control part 150 may adjust the operation of the linear line driving part 114 and the rotation driving part 140 as described above. The control part 150 may adjust a stretching strength and time by the patient or caregiver.

An operation of the upper limb rehabilitation training apparatus having the above-described components will be described as follows.

The arm and hand edge of the patient are seated on the arm rest 110 and the hand rest 120, and the curved and stiffened fingers and palm contact the finger support rods 131 and 132 in the palm direction. Here, as described above, the arm and the hand edge may be easily mounted on the arm and hand rests 110 and 120 regardless of the left and right hands.

Of course, a position of each of the elbow seating part 112 and the finger support rods 131 and 132 may be initially adjusted in consideration of a length of the arm and a size of the hand of the patient.

Then, when the stretching strength and time are inputted by the control part 150, the rotation driving part 140 and the linear line driving part 114 are driven.

Thus, when the hand rest 120 rotates by the rotation driving part 140 in both directions with respect to the arm rest 110, the wrist may be stretched. Also, when the elbow seating part 112 is linearly reciprocated in the longitudinal direction of the main body 111 by the linear line driving part 114, as the arm moves, the fingers and the palm moves in a state where the fingers and the palm are supported by the finger support rods 131 and 132, and thus the fingers and the palm may be stretched.

Also, the upper limb rehabilitation training apparatus according to the current embodiment may operate in various modes and include a continuance mode and a repeat mode according to an operation time or operation method.

A start posture is a state in which the patient having spasticity places his arm and hand on the rehabilitation training apparatus. The start posture may be a posture in which a lot of joints are curved. On the other hand, a target posture may be a posture in which the stiffened arm and hand are relaxed as much as possible by performing stretching as much as possible.

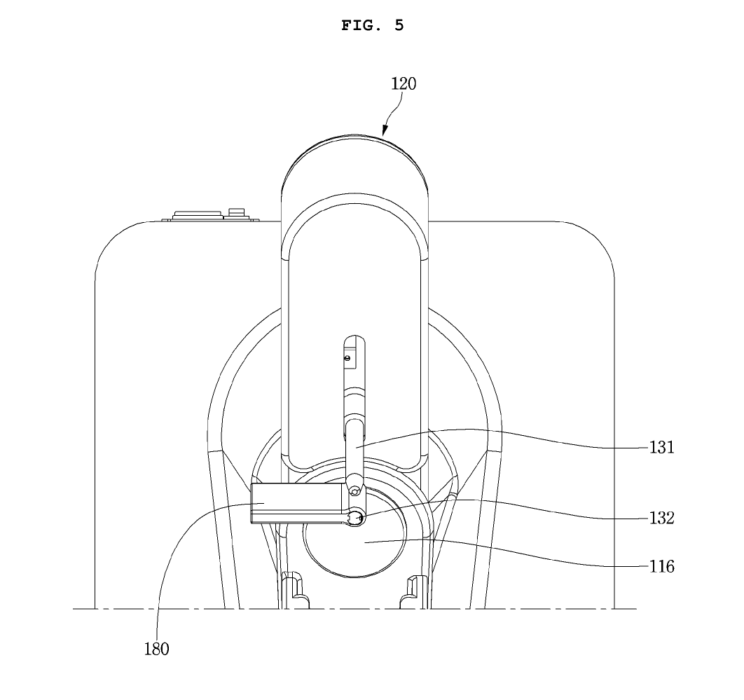

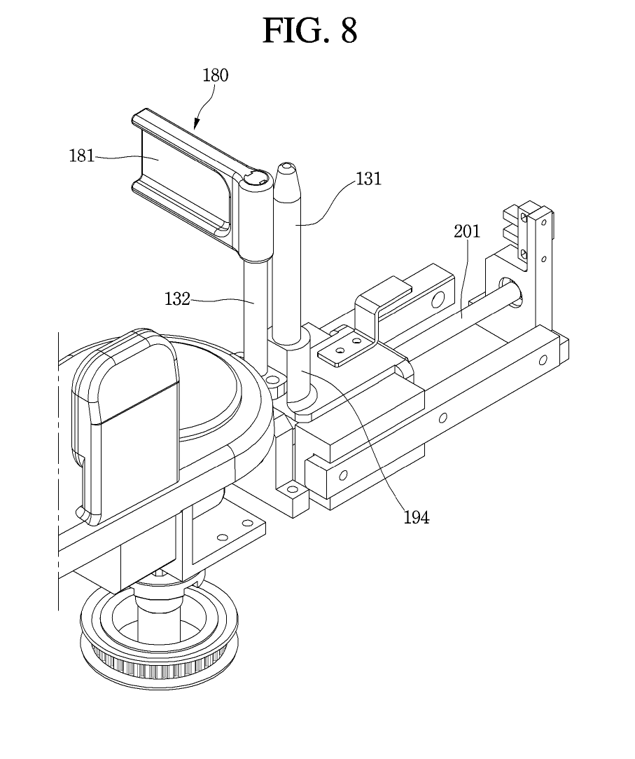

The patient places his arm and hand on the upper limb rehabilitation training apparatus and then may determine whether he continuously performs the stretching. Also, a thumb may be placed on the thumb guide part 180 illustrated in FIGS. 5 to 8. When the hand and fingers of which joints are curved are stretched according to variation of the positions of the support rods 131 and 132, the thumb guide part 180 may prevent a position of the thumb from being dislocated.

The patient may manipulate a controller for determining an operation mode of the upper limb rehabilitation training apparatus to select whether the mode is continuously or repeatedly performed, and whether the mode is returned to the start posture, to set a stretching speed and number in the repeat mode, and to drive the wrist part and finger support rods, and to adjust or select an emergency stop.

When the patient selects the upper limb rehabilitation training apparatus in the continuance mode, the upper limb rehabilitation training apparatus operates so that the upper limb may be stretched up to the target posture of the stretching and maintained in the stretched state for a predetermined time and then be returned to the start posture.

When the patient selects the upper limb rehabilitation training apparatus in the repeat mode, the upper limb rehabilitation training apparatus may guide so that the patient sets the target posture. After the target posture is set, the upper limb rehabilitation training apparatus may guide so that the patient sets the stretching speed and number. In the repeat mode, the stretching may be performed at the preset speed and for the preset number. Then, the upper limb rehabilitation training apparatus may be automatically returned to the start posture to complete the rehabilitation training.

FIGS. 5 to 8 are views minutely illustrating a thumb guide part mountable on the upper limb rehabilitation training apparatus and an operation of the rehabilitation training apparatus.

As described above, a guide part for selectively guiding and fixing the position is disposed on the first finger support rod 131 or the second finger support rod 132. For example, as illustrated in FIG. 5, the thumb guide part 180 for guiding the position of the thumb to the second finger support rod 132 disposed adjacent to a place where the thumb is placed may be disposed in a tightly-fitted manner.

Here, the patient places his thumb to contact the thumb guide part 180 and arm and hand on the rehabilitation training apparatus. Also, while the stretching training performed by spacing apart the finger support rods 131 and 132 from each other or being close the finger support rods 131 and 132 to each other is performed, the thumb may be maintained its position in a state where the thumb contacts the thumb guide part 180.

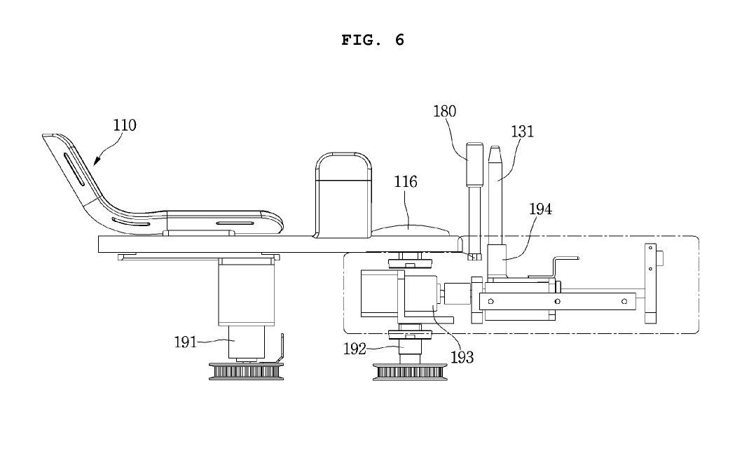

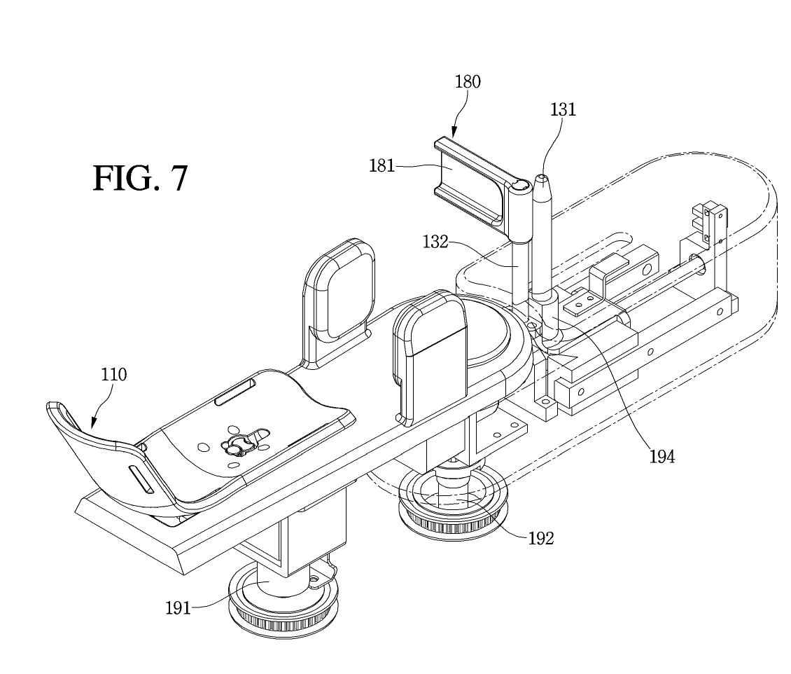

Referring to FIGS. 6 and 7, since the length of the arm varies according to the patients, the arm rest 110 may move to close to the wrist seating part 116, or a first power part 191 for moving the arm rest 110 so that the arm rest 110 is further spaced apart from the wrist seating part 116 may be provided.

Also, a second power part 192 for changing the position of each of the finger support rods 131 and 132 may be provided so that the finger support rods 131 and 132 are spaced apart from each other or disposed close to each other to perform the stretching training.

Also, a third power part 193 for changing the position of the hand rest 120 may be provided. A power generated by the third power part 193 may be transmitted to the first finger support rod 131 along a connection part 194.

According to the above components, the length of the arm, the position of the wrist, and the position of the hand of the patient may be individually adjusted. Also, since the patient selects the various modes of the rehabilitation training, the optimum rehabilitation training may be provided.

In the upper limb rehabilitation training apparatus according to the present disclosure, when the arm and the hand edge are placed on the arm rest and the hand rest, respectively, and the fingers or the palm is supported by the finger support rod in the palm direction, the rotation driving part may be driven to rotate the hand rest with respect to the arm rest on the same plane, thereby automatically stretching the wrist and the fingers.

Thus, since the arm and the hand edge are easily placed on the arm rest and the hand rest disposed on the same plane, and the stiffened and contractured fingers are easily supported on the finger support rod, the patient or caregiver may easily use the rehabilitation training apparatus by himself. Also, the rehabilitation training apparatus may be used regardless of the left hand or right hand to reduce the costs.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An upper limb rehabilitation training apparatus comprising:
an arm rest provided in a longitudinal direction of an arm of a patient;
a hand rest rotatably mounted with respect to the arm rest and on which a hand of the patient is placed;
finger support rods provided in plurality to protrude from a top surface of the hand rest, the finger support rods varying in distance therebetween while supporting fingers or a palm of the patient; and
a rotation driving part providing a driving force so that the hand rest rotates to allow the wrist of the patient to be stretched.

2. The upper limb rehabilitation training apparatus according to claim 1, further comprising a thumb guide part detachably coupled to one of the finger support rod to fix or support a position of a portion of the fingers of the patient.

3. The upper limb rehabilitation training apparatus according to claim 1, further comprising a driving part that provides a power to change a position of the arm rest so that a distance between the arm rest and the hand rest is adjusted.

4. The upper limb rehabilitation training apparatus according to claim 1, wherein the arm rest is inclined upward from an end thereof toward the hand rest, and
the arm rest comprises a main body accommodating the rotation driving part and inclined upward with respect to a floor surface in a longitudinal direction.

5. The upper limb rehabilitation training apparatus according to claim 4, wherein the arm rest further comprises:
an elbow seating part disposed on an upper portion of the main body to allow an elbow of the patient to be seated thereon; and
an arm fixing part disposed on the upper portion of the main body to support both sides of the arm of the patient.

6. The upper limb rehabilitation training apparatus according to claim 5, wherein the elbow seating part is movably disposed in the longitudinal direction of the main body.

7. The upper limb rehabilitation training apparatus according to claim 5, wherein the arm rest further comprises a linear line driving part for moving the elbow seating part to the longitudinal direction of the main body and stretching the fingers or palm of the patient.

8. The upper limb rehabilitation training apparatus according to claim 1, wherein two finger support rods are provided to be spaced a predetermined distance apart from each other in a longitudinal direction of the hand rest.

9. The upper limb rehabilitation training apparatus according to claim 1, wherein the rotation driving part rotates the hand rest in a range of about 120° in both directions with respect to the arm rest.
